(19) United States
(12) Patent Application Publication
(10) Pub. No.: US 2013/0069981 A1
(43) Pub. Date: Mar. 21, 2013

(54) System and Methods for Managing Composition of Surfaces

(71) Applicants: David James Mak-Fan, Waterloo (CA); Aaron Bradley Small, Ottawa (CA)

(72) Inventors: David James Mak-Fan, Waterloo (CA); Aaron Bradley Small, Ottawa (CA)

(73) Assignee: Research In Motion Limited, Waterloo (CA)

(21) Appl. No.: 13/233,967

(22) Filed: Sep. 15, 2011

(51) Int. Cl. G09G 5/00

(52) U.S. Cl. 345/629

(57) ABSTRACT

A system and a method for compositing graphics on a computing device are provided. The computing device includes one or more hardware layers. The method includes determining if the number of surfaces to be displayed by the computing device is more than the number of the hardware layers. If so, two or more of the surfaces are combined to form one or more pseudo surfaces. The combined number of the pseudo surfaces and the remaining ones of the surfaces is equal to or less than the number of the one or more hardware layers. This allows for each of the pseudo surfaces or the remaining ones of the surfaces to be assigned to separate hardware layers. The computational cost for combining the surfaces is also considered during the process.

### TECHNICAL FIELD

The following relates generally to displaying graphics and particularly to managing the composition of surfaces.

### DESCRIPTION OF THE RELATED ART

Many software applications often include graphics that can be displayed on a display screen. Non-limiting examples of display screens include computer monitors, cathode ray tube (CRT) screens, liquid crystal display (LCD) projectors, LCD screens, touch screens, and display screens integrated with computing devices. Different graphics, for example, may be produced by different applications and are composited together to be displayed on a display screen. Such a composition process typically involves software processing and hardware processing.

### BRIEF DESCRIPTION OF THE DRAWINGS

Embodiments will now be described by way of example only with reference to the appended drawings wherein:

FIG. 1 a schematic diagram of an example computing device suitable for compositing images for display on a display screen.

FIG. 2 is a schematic diagram of an example system for compositing multiple surfaces using a composition engine and multiple hardware layers.

FIG. 3 is a plan view of an example computing device and a display screen therefor.

FIG. 4 is a plan view of another example computing device and a display screen therefor.

FIG. 5 is a block diagram of an example embodiment of a computing device.

FIG. 6 is a flow diagram of example computer executable instructions for compositing surfaces to be displayed.

FIG. 7 is a flow diagram of example computer executable instructions for processing a surface directly on a hardware layer.

FIG. 8 is a flow diagram of example computer executable instructions for compositing two or more surfaces before being processed by a hardware layer.

FIG. 9 is a flow diagram of example computer executable instructions for compositing surfaces based on computation costs associated with possible combinations of surfaces.

FIG. 10 is a flow diagram of example computer executable instructions for determining the computation cost for combining two surfaces.

FIG. 11 is a flow diagram of example computer executable instructions for combining four surfaces into a combination suitable to be processed by two hardware layers.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

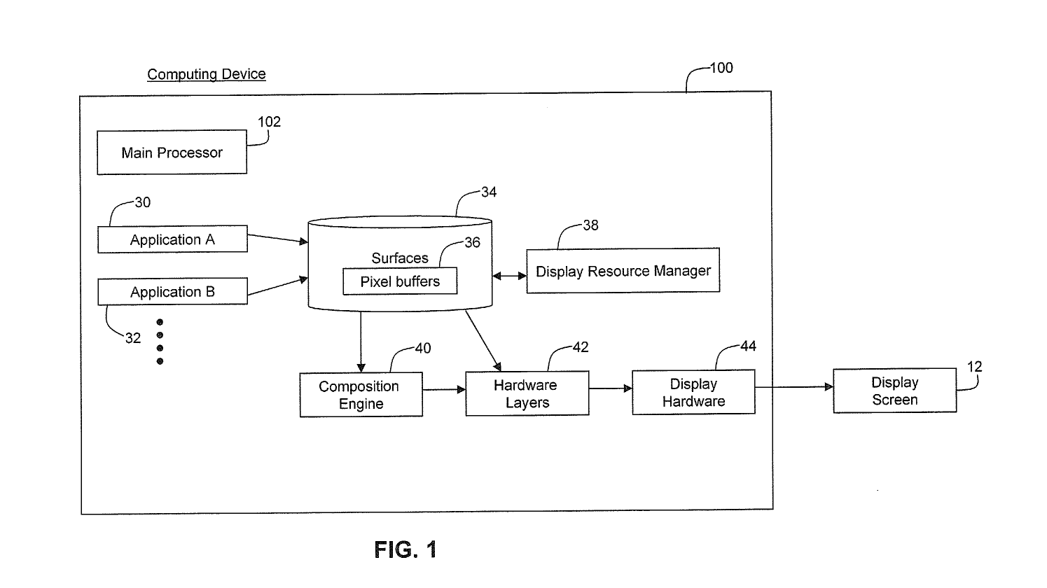

Turning to FIG. 1, a computing device 100 suitable for processing graphics is shown. The computing device 100 is in data communication with a display screen 12. The display screen 12 can be integrated into the computing device 100, such as on a mobile device or tablet, for example, or can be separate from the computing device 100. For example, a computer monitor can be linked by data cables to the computing device 100.

The computing device 100 includes a main processor 102 which can execute software applications, such as application A 30 and application B 32. Non-limiting examples of such applications include web browsers, video players, word processing documents, file managers, an operating system, and calendar applications. The applications 30, 32 may have a graphical component that is to be displayed on the display screen 12. These graphical components include pixels and collectively form surfaces. The surfaces are stored in memory 34, which can include pixel buffers 36. The surfaces can be processed by a composition engine 40, or directly by one or more hardware layers 42. The composition engine 40 may apply graphical transformations to one or more of the surfaces before sending the surfaces to the hardware layers 42. The hardware layers 42 process the surfaces and output the processed surfaces to display hardware 44. The display hardware 44 outputs the graphics that are shown on the display screen 12. The display resource manager 38 manages the display of the surfaces, for example, by providing information about the computing device's capabilities, such as the number of hardware layers 42 and the characteristics of the hardware layers. The composition engine 40 then uses that information to determine which surfaces should be composited by the composition engine 40 and which surfaces should be directly processed by the hardware layers 42. The processor is communicatively coupled to (i.e. in communication with) the applications 30, 32, memory 34, composition engine 40, hardware layers 42, display hardware 44, display resource manager 38 and display screen 12.

The following is a listing of some terms used throughout the present application.

The term “surface” herein refers to an image or graphic having some shape and is able to be displayed on a display screen 12. Non-limiting examples of surfaces includes a blue square, a digital photograph, an image of an icon, and an image containing text. Other non-limiting examples of a surface include a website being displayed on a web browser, a cursor arrow, a tool bar for a word processing application, a calendar's graphical user interface (GUI), and a desktop background. Surfaces, for example, can be layered on top of each other according to a Z-order, blended together, etc.

The terms “combined surfaces”, “composited surfaces”, and “pseudo surface” can be used interchangeably. These terms herein refer to a processed surface that has been created by combining two or more surfaces together. A pseudo surface is different from a surface, since a surface is one that has not been combined with other surfaces.

The term “hardware layer” herein refers to a region of memory representing a rectangular sub-region of the display screen which the display hardware is capable of accepting into the display. The hardware layer may perform some transformations to the surface prior to display, such as, for example, scaling or colour space conversion.

The term “display hardware” herein refers to a part of the main processor which interfaces with the display screen. It retrieves data that is stored in main memory, related to multiple hardware layers. Using the data in main memory, the display hardware forms an image which is drawn on the display screen.

The term “compositing” or “composition” herein refers to the process of combining visual elements from separate sources into a single image, often to create the illusion that all those elements are parts of the same scene or image. For example, multiple surfaces can be composited to form a single surface that is displayed on a display screen.

The term “composition engine” herein refers to a software component which determines how the display hardware is to be used. The composition engine may produce a desired image from a set of surfaces subject to one or more constraints, such as computation costs.

The term “computation cost” herein refers to a value associated with the computational operations to combine two or more surfaces to form a pseudo surface. The computation cost is a value or rating that can be used to signify there is a large or a low amount of computing resources associated with combining two or more surfaces.

The term “CE object” herein refers to a data structure describing a surface and metadata about the surface, such as for example, position, colour space, and orientation.

The term “producer thread” herein refers to a software component that renders images onto surfaces which are to be composited. The producer thread also updates metadata about the surface. Each surface is updated by a producer thread. Different surfaces may be updated by different producer threads.

The term “display thread” is a single system thread which drives the display hardware. It can be considered the last thread to run when performing composition of multiple surfaces.

It can be appreciated that there are two types of composition: composition at the hardware level using hardware layers 42 and composition at the software level using a composition engine 40. For example, the composition engine 40 can be considered a front-end compositor, while the hardware layers 42 can be considered a back-end compositor.

Typically, there are many surfaces that are generated and they are composited into one or more pseudo surfaces at a software level. The composition engine 40 applies various transformations to the pixels in a sequential order, and after each transformation, the processed pixels are copied and stored in buffers. Non-limiting examples of transformations include blending, clipping, scaling, rotations, adjusting transparency settings, and converting the color space. The process of compositing surfaces is quite flexible as it can composite many surfaces, for example, into a single pseudo surface. However, it recognized that the composition process using the composition engine 40 typically involves many sequential steps. This slows down the overall compositing process. The composition engine 40 at the software level also uses a significant amount of memory resources and processing resources, for example, from the main processor 102.

The pseudo surfaces outputted by the composition engine 40 are sent to the hardware layers 40. A hardware layer can composite one buffer containing a surface or a pseudo surface.

A hardware layer can composite a single surface or pseudo surface; if there are multiple surfaces, it can be desirable to first composite the multiple surfaces into a single pseudo surface at a software level. The single pseudo surface can then be processed by a hardware layer. However, compositing the surfaces at a software level can incur more processing time and greater use of memory and processing resources.

It is recognized that compositing at the hardware level is much quicker and more efficient compared to the software level. Therefore, the systems and methods described herein include a computing device 100 with an increased number of hardware layers, in order to facilitate more processing on the hardware level. The systems and methods described herein also include managing the composition process such that a surface does not need to be composited at the software level, and instead can be composited directly at a hardware layer. The systems and methods also distribute the composition of surfaces between the composition engine 40 (e.g. the front end) and the hardware layers 42 (e.g. the back end) in a way that efficiently process the given surfaces based on the available hardware layers 42. Such approaches can significantly reduce the processing time, reduce the memory usage, and can reduce the amount of required processing resources.

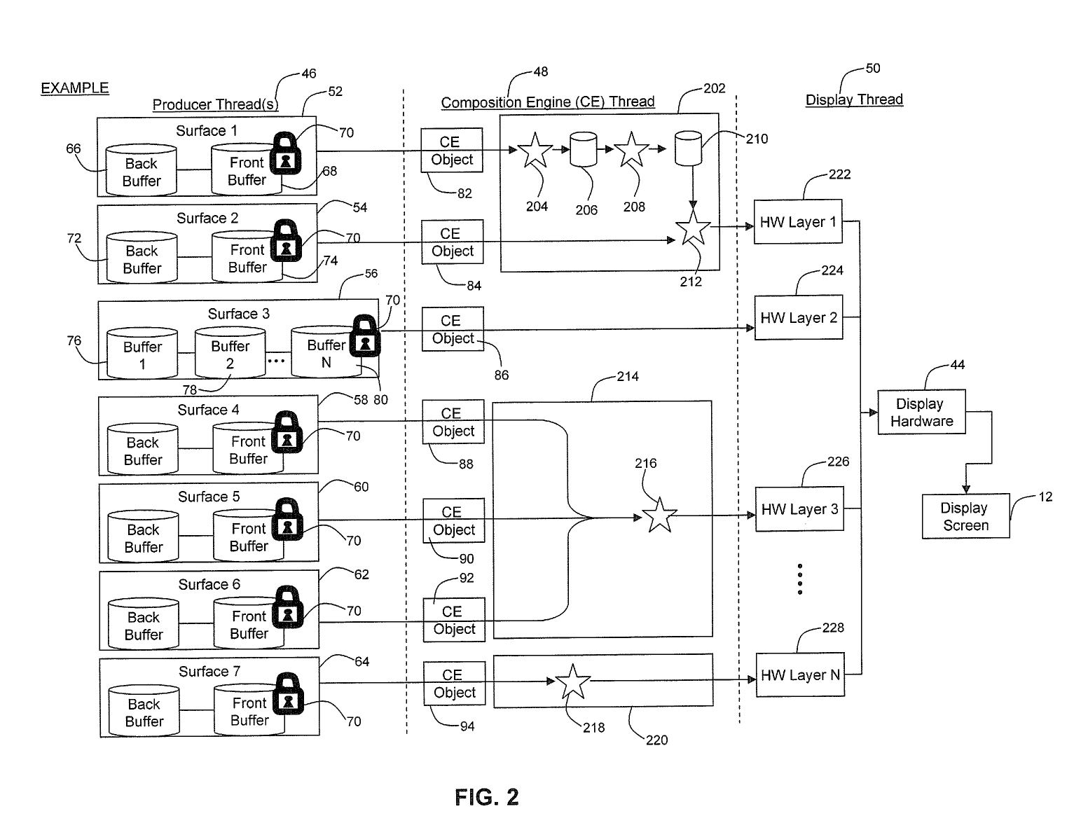

Turning to FIG. 2, an example of a composition system is provided. There are a number of producer threads 46 that generate surfaces 52, 54, 56, 58, 60, 62, 64. These threads of surfaces can be generated from different software applications. The surfaces can pass through the composition engine 40 and are processed as composition engine thread 48. Some surfaces or pseudo surfaces are also passed through the display thread 50, which is where the hardware level processing occurs. The display thread 50 includes hardware layer 1 (222), hardware layer 2 (224), hardware layer 3 (226) and hardware layer N (228). It can be appreciated that the number of hardware layers in the computing device 100 may vary. For example, there can be two hardware layers, four hardware layers, or any other number of hardware layers.

In the example of FIG. 2, surface 1 (52) and surface 2 (54) are composited to a single pseudo surface before being sent to hardware layer 1 (222). Surface 3 (56) is sent to hardware layer 2 (224) for composition without being processed by the composition engine 40. For example, surface 3 (56) is not combined with any other surfaces. Surfaces 4 (58), 5 (60) and 6 (62) are composited onto a single pseudo surface that is sent to hardware layer 3 (226). Surface 7 (64) undergoes a software composition by the composition engine 40, and the processed surface is then sent to hardware layer N (228).

Surface 1 (52), for example, contains a back buffer 66 and a front buffer 68. The back buffer 66 and front buffer 68 are used to avoid contention. In other words, one buffer can be updated by the producer thread 46 while the other buffer is read from the display thread 50. In an example embodiment, a display thread 50 may read from a buffer while a producer thread 46 is updating a buffer, or the display thread 50 may read incompletely rendered data. Each buffer contains the pixels of surface 1 (52). Access to the front buffer 68 is controlled by a semaphore or semaphore lock 70, which can be used to manage shared computing resources. Surface 2 (54) also includes a back buffer 72, a front buffer 74 and a semaphore lock 70. The surfaces 52, 54 are considered by the composition engine 40 to be composition engine objects 82, 84, respectively. Surface 1 (52) is retrieved from the front buffer 68 and a transformation 204 is applied. The transformed surface, including pixels, is stored in a temporary buffer 206. The transformed surface is retrieved from the buffer 206 and another transformation 208 is applied. The further transformed surface is stored in the temporary buffer 210. After the transformations, the further transformed surface is retrieved from the buffer 210 and is combined with the pixels of surface 2 (54) through a transformation 212. The combination of surface 1 (52) and surface 2 (54) forms a pseudo surface which is sent to hardware layer 1 (222) for processing. It can be appreciated that the collection of transformations can be considered an object rendering process 202. In an example embodiment, transformation 204 is a rotation, and transformation 208 is a conversion of surface l's color space to match surface 2's color space.

Surface 3 includes any number of buffers, which can be represented by buffer 1 (76), buffer 2 (78) and buffer N (80). Buffer N (80) is also access controlled by a semaphore lock 70. Using several buffers is useful in a case where the producer thread 46 knows in advance the future state buffers, but renders at an unsteady rate. In this case, it smoothes out the unsteady rendering rate. This approach to buffering may come at a cost in latency, but usually where latency is not important. This approach is used for example in video. For example, it allows some video frames to be rendered too slowly to meet animation deadlines, but smoothes out the rendering rate to be steady in the long-term. The pixels of surface 3 (56) are obtained from buffer N (80) and are passed to hardware layer 2 (224) without any processing from the composition engine 40. In an example embodiment, the pixels of surface 3 (56) can pass through the composition engine 40 as a composition object 86.

Surfaces 4 (58), 5 (60) and 6 (62) are considered as composition engine objects 88, 90 and 92 respectively. They are combined together through a transformation 216, which results in a single pseudo layer. This output of the object rendering process 214 is sent to hardware layer 3 (226).

Surface 7 (64), which can be considered as composition engine object 94, is processed according to a transformation 218 in the object rendering process 220. For example, the transformation 218 can be a conversion from one color space to another color space that is better suited to hardware layer N (228) or the display hardware 44. The processed surface is sent to hardware layer N (228).

Continuing with the example in FIG. 2, the surfaces or pseudo surfaces are processed by the hardware layers 222, 224, 226, 228 in parallel and their outputs are sent to the display hardware 44. The display hardware 44 processes the surfaces to be displayed on the display screen 12. In an example embodiment, the display hardware 44 takes the data from the hardware layers 222, 224, 226, 228, which are considered non-contiguous memory regions, as well as the metadata about these regions. The metadata includes, for example, the x, y, z coordinates, width, height, colour space, scaling, orientation, global alpha color and transparent colour. Based on the data, the display hardware 44 uses the x, y, z coordinates, which are on a common scale to all hardware layers, to produce and output a single image to be displayed on the display screen 12.

It can be appreciated that the configuration and transformations in FIG. 2 are just an example. The number of surfaces, the combination of surfaces, the transformations of the surfaces, and the number of hardware layers can vary.

It will be appreciated that a computing device 100 includes, for example, pagers, cellular phones, cellular smart-phones, wireless organizers, personal digital assistants, computers, laptops, handheld wireless communication devices, wirelessly enabled notebook computers, tablet devices and the like. Such devices will hereinafter be commonly referred to as “computing devices” for the sake of clarity.

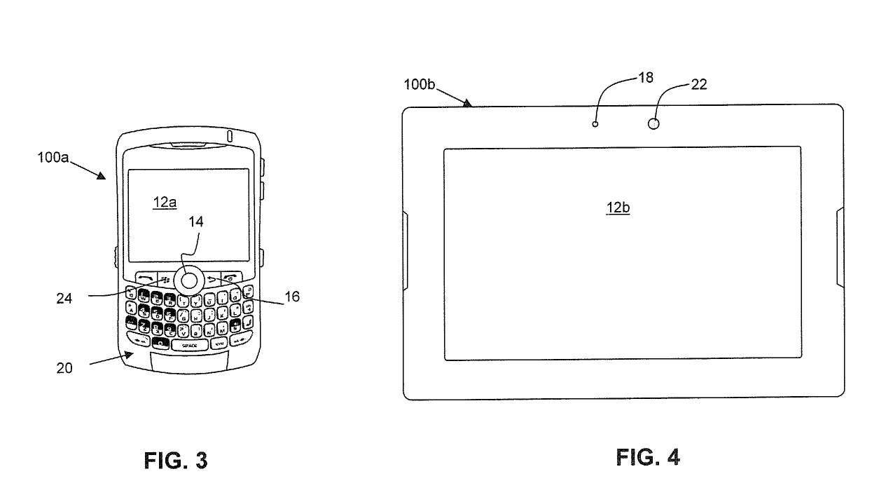

Referring to FIGS. 3 and 4, one example embodiment of a computing device 100a is shown in FIG. 3, and another example embodiment of a computing device 100b is shown in FIG. 4. It will be appreciated that the numeral “100” will hereinafter refer to any computing device 100, including the example embodiments 100a and 100b, those example embodiments enumerated above or otherwise. It will also be appreciated that a similar numbering convention may be used for other general features common between all figures such as a display screen 12a, a positioning device 14, a cancel or escape button 16, and a menu or option button 24. Computing device 100a is shown with a full QWERTY keyboard 20.

It will be appreciated that for the computing device 100, a wide range of one or more cursor or view positioning devices or input devices (such as e.g. a touch pad, a positioning wheel, a joystick button, a mouse, a touch screen, a set of arrow keys, a tablet, an accelerometer (for sensing orientation and/or movements of the computing device 100 etc.), or other whether presently known or unknown), may be employed. Similarly, any variation of keyboard a 20 may be used. It will also be appreciated that the computing devices 100 shown in FIGS. 3 and 4 are for illustrative purposes only and various other computing devices 100 are equally applicable to the following examples.

The computing device 100b in FIG. 4 includes a microphone 18 and a camera 22. The display screen 12b is a touch screen display able to receive inputs through a user's touch. The computing device 100b can be considered to be a tablet device.

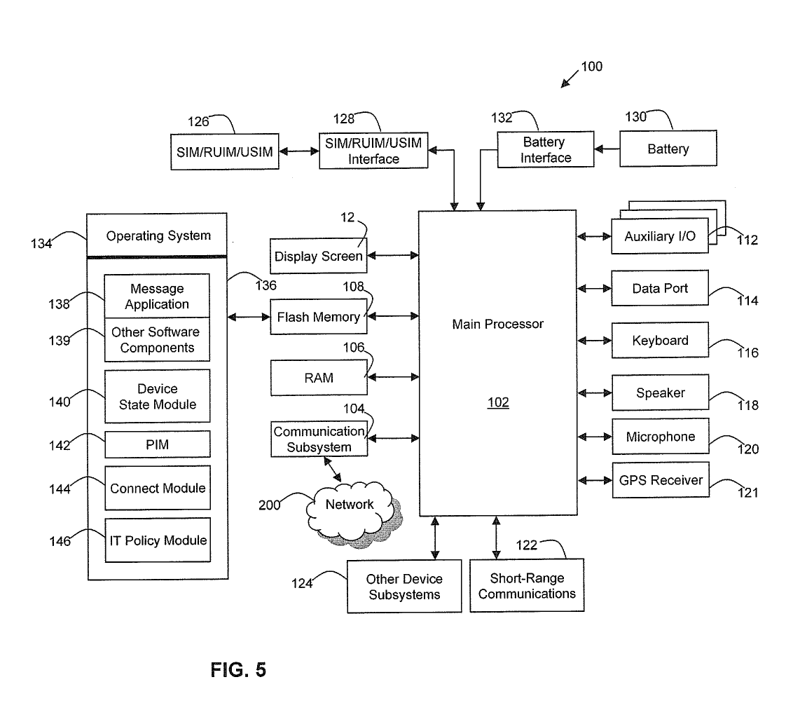

An example configuration for a computing device 100 is illustrated in FIG. 5. Shown therein is a block diagram of an example embodiment of a computing device 100. The computing device 100 includes a number of components such as a main processor 102 that controls the overall operation of the computing device 100. Communication functions, including data and voice communications, are performed through a communication subsystem 104. The communication subsystem 104 receives messages from and sends messages to a wireless network 200. In this example embodiment of the computing device 100, the communication subsystem 104 is configured in accordance with the Global System for Mobile Communication (GSM) and General Packet Radio Services (GPRS) standards, which is used worldwide. Other communication configurations that are equally applicable are the 3G and 4G networks such as EDGE, UMTS and HSDPA, LTE, Wi-Max etc. New standards are still being defined, but it is believed that they will have similarities to the network behaviour described herein, and it will also be understood by persons skilled in the art that the example embodiments described herein are intended to use any other suitable standards that are developed in the future. The wireless link connecting the communication subsystem 104 with the wireless network 200 represents one or more different Radio Frequency (RF) channels, operating according to defined protocols specified for GSM/GPRS communications.

The main processor 102 also interacts with additional subsystems such as a Random Access Memory (RAM) 106, a flash memory 108, a display 12, an auxiliary input/output (I/O) subsystem 112, a data port 114, a keyboard 116, a speaker 118, a microphone 120, a GPS receiver 121, short-range communications 122, a camera 123, a magnetometer 125, and other device subsystems 124. The display 12 can be a touch screen display able to receive inputs through a user's touch.

Some of the subsystems of the computing device 100 perform communication-related functions, whereas other subsystems may provide “resident” or on-device functions. By way of example, the display 12 and the keyboard 116 may be used for both communication-related functions, such as entering a text message for transmission over the network 200, and device-resident functions such as a calculator or task list.

The computing device 100 can send and receive communication signals over the wireless network 200 after required network registration or activation procedures have been completed. Network access is associated with a subscriber or user of the computing device 100. To identify a subscriber, the mobile device 100 may use a subscriber module component or “smart card” 126, such as a Subscriber Identity Module (SIM), a Removable User Identity Module (RUIM) and a Universal Subscriber Identity Module (USIM). In the example shown, a SIM/RUIM/USIM 126 is to be inserted into a SIM/RUIM/USIM interface 128 in order to communicate with a network. Without the component 126, the computing device 100 is not fully operational for communication with the wireless network 200. Once the SIM/RUIN/USIM 126 is inserted into the SIM/RUIM/USIM interface 128, it is coupled to the main processor 102.

The computing device 100 may be a battery-powered device and includes a battery interface 132 for receiving one or more rechargeable batteries 130. In at least some example embodiments, the battery 130 can be a smart battery with an embedded microprocessor. The battery interface 132 is coupled to a regulator (not shown), which assists the battery 130 in providing power V+ to the mobile device 100. Although current technology makes use of a battery, future technologies such as micro fuel cells may provide the power to the mobile device 100.

The computing device 100 also includes an operating system 134 and software components 136 which are described in more detail below. The operating system 134 and the software components 136 that are executed by the main processor 102 are typically stored in a persistent store such as the flash memory 108, which may alternatively be a read-only memory (ROM) or similar storage element (not shown). Those skilled in the art will appreciate that portions of the operating system 134 and the software components 136, such as specific device applications, or parts thereof, may be temporarily loaded into a volatile store such as the RAM 106. Other software components can also be included, as is well known to those skilled in the art.

The subset of software applications 136 that control basic device operations, including data and voice communication applications, may be installed on the computing device 100 during its manufacture. Software applications 136 may include a message application 138, a device state module 140, a Personal Information Manager (PIM) 142, a connect module 144 and an IT policy module 146. A message application 138 can be any suitable software program that allows a user of the computing device 100 to send and receive electronic messages, wherein messages are typically stored in the flash memory 108 of the computing device 100. A device state module 140 provides persistence, i.e. the device state module 140 ensures that important device data is stored in persistent memory, such as the flash memory 108, so that the data is not lost when the computing device 100 is turned off or loses power. A PIM 142 includes functionality for organizing and managing data items of interest to the user, such as, but not limited to, e-mail, contacts, calendar events, and voice mails, and may interact with the wireless network 200. A connect module 144 implements the communication protocols that are required for the mobile device 100 to communicate with the wireless infrastructure and any host system, such as an enterprise system, that the computing device 100 is authorized to interface with. An IT policy module 146 receives IT policy data that encodes the IT policy, and may be responsible for organizing and securing rules such as the “Set Maximum Password Attempts” IT policy.

Other types of software applications or components 139 can also be installed on the computing device 100. These software applications 139 can be pre-installed applications or third party applications, which are added after the manufacture of the mobile device 100. Examples of third party applications include games, calculators, utilities, etc.

The additional applications 139 can be transmitted to the computing device 100 through at least one of the wireless network 200, the auxiliary I/O subsystem 112, the data port 114, the short-range communications subsystem 122, or any other suitable device subsystem 124.

The data port 114 can be any suitable port that enables data communication between the mobile device 100 and another computing device. The data port 114 can be a serial or a parallel port. In some instances, the data port 114 can be a USB port that includes data lines for data transfer and a supply line that can provide a charging current to charge the battery 130 of the computing device 100.

For voice communications, received signals are output to the speaker 118, and signals for transmission are generated by the microphone 120. Although voice or audio signal output is accomplished primarily through the speaker 118, the display 110 can also be used to provide additional information such as the identity of a calling party, duration of a voice call, or other voice call related information.

It will be appreciated that any module or component exemplified herein that executes instructions or operations may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data, except transitory propagating signals per se. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the computing device 100, or accessible or connectable thereto. Any application or module herein described may be implemented using computer readable/executable instructions or operations that may be stored or otherwise held by such computer readable media.

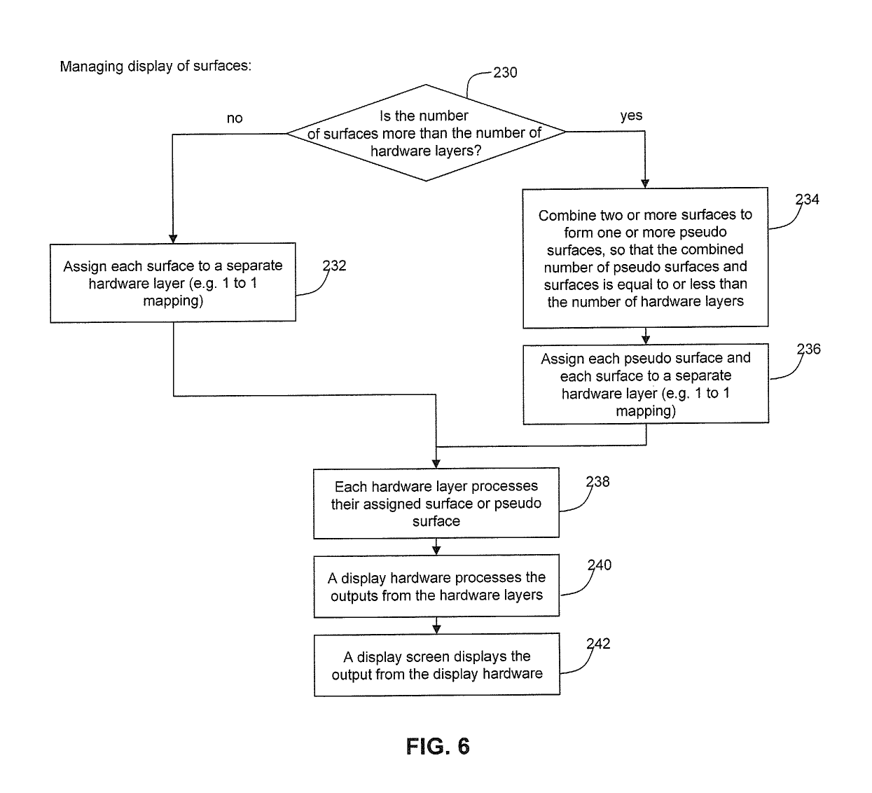

Turning now to FIG. 6, example computer executable instructions are provided for managing the display of surfaces. At block 230, it is determined if the number of surfaces, for example from the producer threads 46, is more than the number of hardware layers. If not, then each surface is assigned to its own hardware layer, for example using a 1-to-1 mapping (block 232). In other words, the number of surfaces is less than or equal to the number of hardware layers. In this way, the surfaces do not need to be combined into a pseudo layer, and the surfaces can be more quickly processed on the back end.

If there are more surfaces than hardware layers, at block 234, two or more surfaces are combined to form one or more pseudo surfaces. A certain number of combinations are made at least until the total or combined number of pseudo surfaces and surfaces is equal to the number of hardware layers. It is possible that there may be one or more combinations that results in the total number of pseudo surfaces and surface being less than the number of hardware layers. At block 236, each pseudo surface and each surface is assigned to a separate hardware, for example in a 1-to-1 mapping.

For example, referring briefly back to FIG. 2, seven surfaces were combined in a way to form two pseudo surfaces with two remaining surfaces (i.e. surface 3 (56) and surface 7 (64)). The resulting total number of the pseudo surfaces and surfaces is four, which matches the number of the four hardware layers 222, 224, 226 and 228.

Referring back to FIG. 6, upon mapping the surfaces to the hardware layers 42, each hardware layer processes their assigned surface or pseudo surface (block 238). The display hardware 44 then processes the outputs from the hardware layers 42 (block 240). A display screen 12 displays the output from the display hardware 44 (block 242).

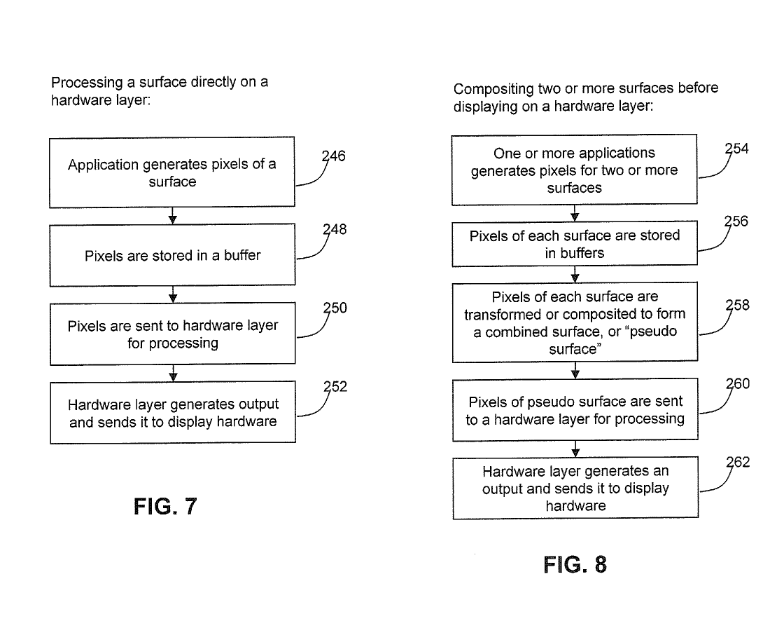

Turning to FIG. 7, example computer executable instructions are provided for processing a surface directly on a hardware layer. The instructions of FIG. 7, for example, can be applied to processing surface 3 (56) using hardware layer 2 (224) shown in FIG. 2. Referring to FIG. 7, at block 246, an application generates pixels of a surface. At block 248, the pixels are stored in a buffer. At block 250, the pixels are sent to a hardware layer for processing. At block 252, the hardware layer generates an output and sends the output to the display hardware 44.

Turning to FIG. 8, example computer executable instructions are provided for compositing two or more surfaces before being sent to a hardware layer. Such instructions could apply to the combination of surface 1 (52) and surface 2 (54) before being processed by hardware layer 1 (222), as per FIG. 2. The instructions could also apply, for example, to the combination of surfaces 4 (58), 5 (60) and 6 (62), which are composited before being processed by hardware layer 3 (block 226). Referring to FIG. 8, at block 254, one or more applications generate pixels for two or more surfaces. At block 256, pixels of each surface are stored in buffers. At block 258, pixels of each surface are transformed or composited to form a combined surface, or pseudo surface. At block 260, pixels of the pseudo surface are sent to a hardware layer for processing. At block 262, the hardware layer generates an output and sends it to the display hardware 44 for processing.

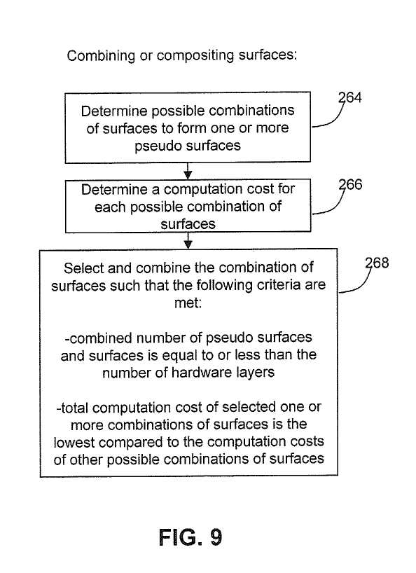

Turning to FIG. 9, example computer executable instructions are provided for combining or compositing surfaces. Such instructions would be implemented, for example, upon deciding that there are more surfaces than hardware layers. At block 264, the computing device 100 determines the possible combinations of surfaces to form one or more pseudo surfaces. At block 266, a computation cost is determined for each possible combination of surfaces. In other words, each possible combination of surfaces is associated with a computation cost. In an example embodiment, the only possible combinations that are considered are those that will reduce the total number of surfaces and pseudo surface to be equal to or less than the number of hardware layers. By applying such a criterion, the number of possible combinations of surface is reduced, thereby also reducing the number of computations.

At block 268, the computing device 100 selects and processes the one or more combinations of surfaces that meet at least the following two criteria. One criterion is that the combined number of surfaces and pseudo surfaces is equal to or less than the number of hardware layers. Another criterion is that the total computation cost of the selected one or more combinations of surfaces is the lowest cost compared to the computation costs of other possible combinations of surfaces.

Determining the computation cost for combining surfaces may depend on the attributes of the surfaces or pseudo surfaces. In turn, such attributes may determine the type and number of transformations required to composite two surfaces. For example, the higher the number of transformations used, or the more complicated the transformations, then the more computing resources and time are required to composite two surfaces together on the software level.

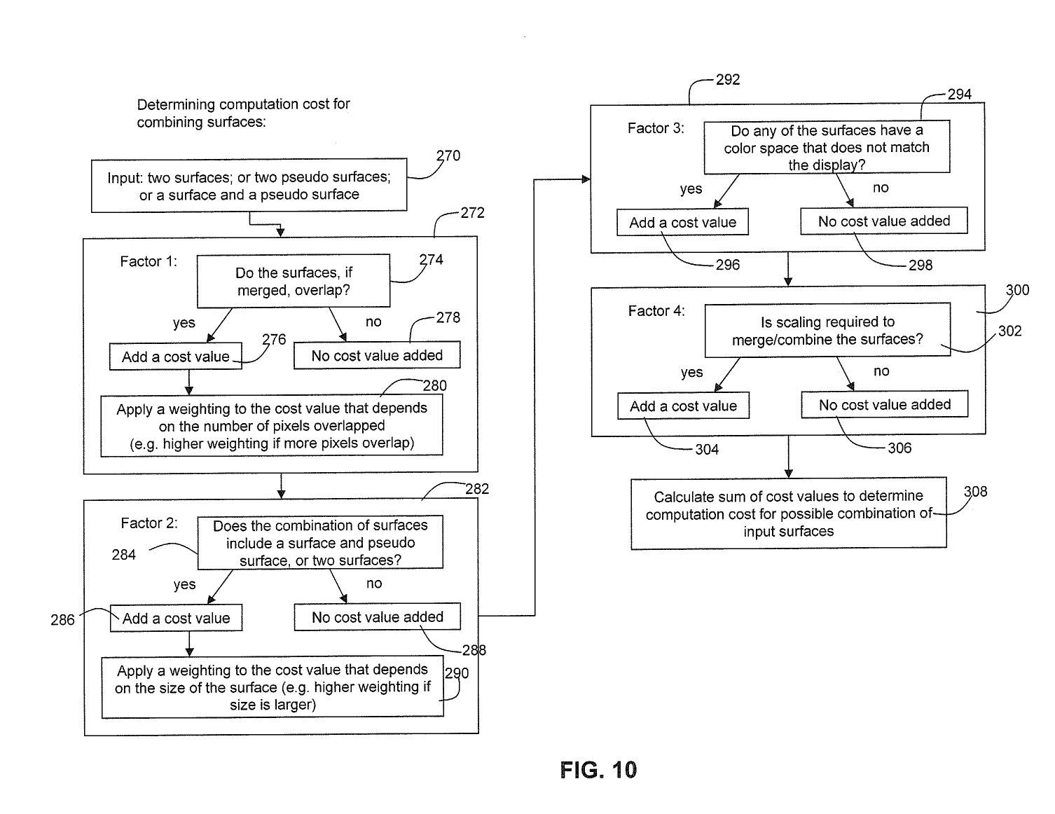

Turning to FIG. 10, example computer executable instructions are provided for determining a computation cost for combining surfaces. Various factors are considered and a cost value is determined based on the factors. At block 270, the input can be two surfaces, two pseudo surfaces, or a pseudo surface and a surface. For example, a pseudo surface, which is a result of two already combined surfaces, can be further combined with another surface or another pseudo surface. In another example, the input may be any number of surfaces or pseudo surfaces, or both, which are to be combined. For clarity, the surfaces and pseudo surfaces as described with respect to FIG. 10 are generically referred to as “surfaces”.

It can also be appreciated that although the factors 272, 282, 292 and 300 are shown in an example order, computation of the factors can occur in any order.

At block 272, a first factor is considered. Particularly, at block 274, it is determined whether the surfaces, if merged or combined, would overlap. If not, at block 278, no cost value is added. If so, at block 276, a cost value is added. At block 280, a weighting is applied to the cost value, which depends on the number of pixels from the surfaces. For example, the higher the number of pixels that overlap, the higher the weighting.

At block 282, a second factor 282 considers at block 284 if the combination of surfaces includes a surface and a pseudo surface, or two surfaces. In other words, does the combination include combining at least one surface with some other surface? If not, then no cost value is added (block 288). If so, a cost value is added (block 286). A cost value is added if a surface is present in the combination since a single surface can typically be processed by a hardware layer very quickly, and by combining such surface with another surface would mean eliminating the possibility of having the single surface processed alone on a hardware layer. Giving up such an efficient computation is considered to incur a computation cost. At block 290, a weighting is applied to the cost value depending on the size of the surface. For example, a higher weighting is applied when the single surface is larger. This example relationship between the weighting and the surface size is in consideration of the possible computational efficiencies gained when a single large surface is processed directly by a hardware layer. Thus, the larger the possible efficiency that is lost, the higher the cost penalty.

Factor 3 (292) determines at block 294, whether any of the surfaces have a color space that does not match the display hardware, or does not match the color space of the other surface with which it is to be combined. For example, a surface may be characterised by a YUV color space, while the display hardware operates in the RGB color space. Therefore, the surface's color space needs to be converted to the RGB color space. In another example, one surface may have an RGB color space, and another surface may have a HSV color space. The other surface may then require a color space conversion to the RGB color space, so that the two surfaces can be composited into a single surface. Therefore, if the color spaces do not match, at block 296, a cost value is added. If the color spaces do match, at block 298, no cost value is added.

Factor 4 (300) considers whether scaling is required to merge or combine the surfaces (block 302). If so, a cost value is added (block 304). If not, no cost value is added (block 306). The cost values from the different factors are then combined, and their sum is the computation cost associated with the possible combination of the inputted surfaces (block 308).

It can be appreciated that there may be other factors that can be used to add or detract from the computation cost. There may also be other factors that can add or decrease the weightings of factors. For example, if a certain surface has a certain characteristic, and a certain hardware layer supports the certain characteristic, then that certain surface is assigned to be processed by that certain hardware layer.

The computation costs can be used in many ways to manage the process of combining surfaces. One example approach is to select the combinations that produce the lowest cost. Another example approach is to provide upper limits. In other words, viable combinations that have computation costs above a certain threshold are not accepted. In another example approach, combinations that have computation costs within a certain range of computation costs, or below a certain threshold, are acceptable.

In another example embodiment, another criterion is applied to determine the mapping or surfaces to different hardware layers. The criterion considers the color space as well as the Z-order of a surface. In particular, surfaces characterized by a certain colour space (e.g. YUV color space) are assigned to a mid-level hardware layer. These surfaces also have associated a Z-order. In general, surfaces that do not have the certain color space are mapped to other hardware levels based on their Z-order. Surfaces with Z-orders lower than Z-order of the surface characterized by the certain color can be processed by a set of one or more hardware levels. Surfaces with Z-orders higher than Z-order of the surface characterized by the certain color can be processed by another set of one or more hardware levels. The management of the surfaces on the hardware levels can also take into account the computation cost.

For example, a first surface has a Z-order of one and has an RGB color space. A second surface has a Z-order of two and has a YUV color space. A third, a fourth and a fifth surface each have a Z-order of three and higher and have a RGB color space. In this example, the second surface, having the certain color space YUV, is assigned to a second hardware level. Since the first surface has a Z-order of one, and does not have the YUV color space, it is assigned to another hardware level (e.g. a first hardware level). Similarly, since the third, fourth and fifth surfaces have higher Z-orders than the Z-order of second surface, and these surfaces do not have the YUV color space, then these surfaces are assigned to other hardware levels, other than the second hardware level. For example, the third, fourth and fifth surfaces can be shown one hardware level (e.g. a third hardware level), or multiple other hardware levels (e.g. a third and a fourth hardware level).

In another example of the criterion, a first surface has a Z-order of one and has an RGB color space. A second surface has a Z-order of two and has a YUV color space. A third and fourth surface have a Z-order of three and four and have a RGB color space. A fifth surface has a Z-order of five and has a YUV color space. A sixth surface has a Z-order of six and has a RGB color space. In this example, both the second surface and the fifth surface are composited onto a single pseudo surface which is sent to a hardware layer, for example, a second hardware layer. However, since there are other surfaces, which do not have the YUV color space, but have Z-order values between the two YUV colored surfaces (e.g. Z-order values between 2 and 5), therefore, these other surfaces are also composited into the pseudo surface. In other words, the third and fourth surfaces, in addition to the second and the fifth surfaces, are all composited onto a single pseudo surface to be assigned a hardware layer. The other surfaces, namely the first surface and the sixth surface, can be composited into another pseudo surface, or can be assigned directly to other hardware layers. A computation cost approach can be used in addition with the color and Z-order criterion to determine whether or not surfaces should be composited.

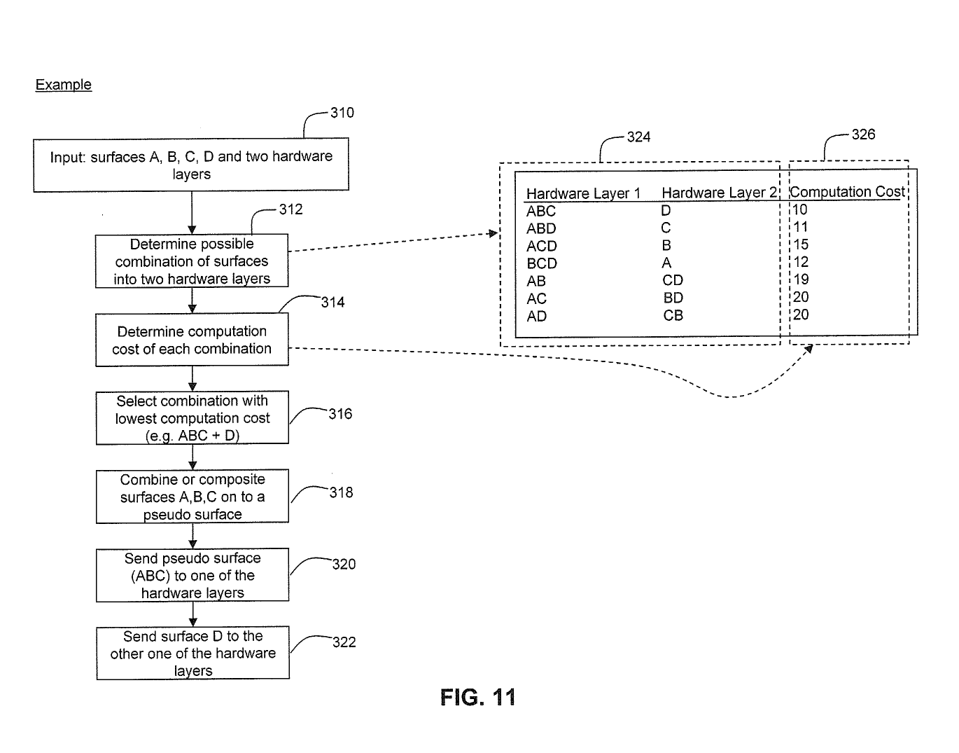

Turning to FIG. 11, example computer executable instructions are provided for determining an appropriate combination of four surfaces A, B, C and D which are to be processed on two hardware layers. Therefore, the four surfaces must be combined in such a way so that the total number of pseudo surfaces plus the number of surfaces which are not composited into pseudo surfaces, is two or less. Typically, all the hardware layers are to be used in order to increase the composition efficiency. In this example, the possible combinations of surfaces are therefore suited for the use of two hardware layers.

Referring to block 310, the inputs are the surfaces A, B, C and D, and two hardware layers. At block 312, the computing device 100 determines the possible combinations of surfaces amongst the two hardware layers. Some possible combinations are shown in table 324. For example, surfaces A, B and C can be combined into one pseudo surface and be processed by one of the hardware layers, while surface D can be processed on the other one of the hardware layers. In another possible combination, the surfaces A and D can be composited and processed by one of the hardware layers, while the surfaces C and B can be composited and displayed on the other of the hardware layers.

The computation cost of each combination is then determined (block 314). The corresponding computation costs are shown in table 326. For example, the combination of surfaces A,B,C on one hardware layer and surface D on another hardware layer has a computation cost of 10. In another example, the combination of surfaces A,D on one hardware layer and the combination of surfaces C,B on another hardware layer has a total computation cost of 20.

At block 316, the combination with the lowest computation cost is selected. In the example of the tables 324 and 326, the combination with the lowest computation cost is the pseudo surface including surfaces A, B, C, to be processed on one hardware layer, and the surface D, to be processed on the other hardware layer. In this way, the above systems and methods efficiently allocate processing resources.

At block 318, the selected combination or combinations of surfaces are then composited on to at least one pseudo surface. For example, surfaces A. B and C are composited on to a pseudo surface. At block 320, the pseudo surface is sent to one of the hardware layers. Surface D is sent to another hardware layer (block 322).

In general, an example method is provided for compositing graphics on a computing device, whereby the computing device includes one or more hardware layers. The method includes determining if the number of one or more surfaces to be displayed by the computing device is more than the number of the one or more hardware layers, and if so: combining at least two of the one or more surfaces to form one or more pseudo surfaces, wherein the combined number of the one or more pseudo surfaces and any remaining ones of the one or more surfaces is equal to or less than the number of the one or more hardware layers; and assigning each of the one or more pseudo surfaces or the any remaining ones of the one or more surfaces, or both, to a separate one of the one or more hardware layers. However, if the number of the one or more surfaces is less than or equal to the number of the one or more hardware layers, then the computing device assigns each of the one or more surfaces to a separate one of the one or more hardware layers.

In another aspect, the one or more hardware layers includes four or more hardware layers. In another aspect, upon combining the at least two of the one or more surfaces, the number of the any remaining ones of the one or more surfaces is zero. In another aspect, a front-end compositor combines the one or more surfaces to form the one or more pseudo surfaces using one or more sequential operations. In another aspect, the any remaining ones of the one or more surfaces are not processed by the front-end compositor and are retrieved from a memory by the one or more hardware layers, the memory storing the one or more surfaces. In another aspect, if the number of the one or more surfaces is less than or equal to the number of the one or more hardware layers, the one or more surfaces are sent directly to a back-end compositor including the one or more hardware layers, the back-end compositor performing computations in parallel. In another aspect, certain ones of the one or more surfaces with a certain characteristic are assigned to certain ones of the one or more hardware layers that support the certain characteristic. In another aspect, if the number of the one or more surfaces is more than the number of the one or more hardware layers, the computing device determining one or more possible combinations of surfaces to form the one or more pseudo surfaces, and determining a computation cost associated with each of the one or more possible combinations of surfaces. In another aspect, the method further includes selecting one of the one or more possible combinations of surfaces that has a lowest computation cost. In another aspect, the method further includes selecting at least one of the one or more possible combinations of surfaces that has a computation cost below a certain threshold.

In general, a computing device for compositing graphics is provided. The computing device includes: at least one hardware layer; and display hardware in communication with the at least one hardware layer; a memory storing at least one surface, at least one software application for generating the at least one surface, and a composition engine for compositing the at least one surface; and a processor, in communication with the display hardware, the at least one hardware layer and the memory. The processor is configured to determine if the number of the at least one surface is more than the number of the at least one hardware layer, and if so: combines at least two of the at least one surface to form at least one pseudo surface; and assigns each of the at least one pseudo surface or any remaining ones of the at least one surface to a separate one of the at least one hardware layer. If the number of the at least one surface is less than or equal to the number of the at least one hardware layer, the processor assigns each of the at least one surface to a separate one of the at least one hardware layer.

Another example method is provided for evaluating a cost for potentially combining two or more surfaces into a pseudo surface. The method includes: determining a cost associated with a first factor, the first factor based on whether or not the surfaces overlap when combined; determining a cost associated with a second factor, the second factor based on whether or not at least one of the surfaces includes two previously combined surfaces; determining a cost associated with a third factor, the third factor based on whether or not a color space of any one of the surfaces is to be converted to another color space when combining the surfaces; determining a cost associated with a fourth factor, the fourth factor based on whether or not scaling is used when combining the surfaces; and computing a sum of the costs associated with any one or more of the first, the second, the third and the fourth factors, the sum of the costs set as the cost for potentially combining the surfaces into the pseudo surface.

In another aspect, if the surfaces overlap, the cost associated with the first factor increases. In another aspect, if at least one of the surfaces includes two previously combined surfaces, the cost associated with the second factor increases. In another aspect, if the color space of any one of the surfaces is to be converted to the other color space, the cost associated with the third factor increases. In another aspect, if the scaling is used, the cost associated with the fourth factor increases.

The schematics and block diagrams used herein are just for example. Different configurations and names of components can be used. For instance, components and modules can be added, deleted, modified, or arranged with differing connections without departing from the spirit of the invention or inventions.

The steps or operations in the flow charts and diagrams described herein are just for example. There may be many variations to these steps or operations without departing from the spirit of the invention or inventions. For instance, the steps may be performed in a differing order, or steps may be added, deleted, or modified.

It will be appreciated that the particular example embodiments shown in the figures and described above are for illustrative purposes only and many other variations can be used according to the principles described. Although the above has been described with reference to certain specific example embodiments, various modifications thereof will be apparent to those skilled in the art as outlined in the appended claims.

1. A method for compositing graphics on a computing device comprising:
determining if a number of at least one surface to be displayed by the computing device is more than a number of at least one hardware layer of the computing device, and if so:
combining at least two of the at least one surface to form at least one pseudo surface;
assigning each of the at least one pseudo surface and any remaining ones of the at least one surface to a separate one of the at least one hardware layer; and
if the number of the at least one surface is less than or equal to the number of the at least one hardware layer, assigning each of the at least one surface to a separate one of the at least one hardware layer.

2. The method of claim 1 wherein the combined number of the at least one pseudo surface and any remaining ones of the at least one surface is equal to or less than the number of the at least one hardware layer.

3. The method of claim 1 wherein the at least one hardware layer comprises four or more hardware layers.

4. The method of claim 1 wherein, upon combining the at least two of the at least one surface, the number of the any remaining ones of the at least one surface is zero.

5. The method of claim 1 wherein a front-end compositor combines the at least one surface to form the at least one pseudo surface using at least one sequential operation.

6. The method of claim 5 wherein the any remaining ones of the at least one surface are not processed by the front-end compositor and are retrieved from a memory by the at least one hardware layer, the memory storing the at least one surface.

7. The method of claim 1 wherein if the number of the at least one surface is less than or equal to the number of the at least one hardware layer, the at least one surface is sent directly to a back-end compositor comprising the at least one hardware layer, the back-end compositor performing computations in parallel.

8. The method of claim 1 wherein certain ones of the at least one surface with a certain characteristic are assigned to certain ones of the at least one hardware layer that support the certain characteristic.

9. The method of claim 1 further comprising, if the number of the at least one surface is more than the number of the at least one hardware layer, the computing device determining at least one possible combination of surfaces to form the at least one pseudo surface, and determining a computation cost associated with each of the at least one possible combination of surfaces.

10. The method of claim 9 further comprising selecting one of the at least one possible combination of surfaces that has a lowest computation cost.

11. The method of claim 9 further comprising selecting at least one of the at least one possible combination of surfaces that has a computation cost below a certain threshold.

12. A computing device for compositing graphics, comprising:
at least one hardware layer; and
display hardware in communication with the at least one hardware layer;
a memory storing at least one surface, at least one software application for generating the at least one surface, and a composition engine for compositing the at least one surface;
a processor, in communication with the display hardware, the at least one hardware layer and the memory, that is configured to determine if the number of the at least one surface is more than the number of the at least one hardware layer, and if so:
combines at least two of the at least one surface to form at least one pseudo surface;
assigns each of the at least one pseudo surface or any remaining ones of the at least one surface to a separate one of the at least one hardware layer; and
if the number of the at least one surface is less than or equal to the number of the at least one hardware layer, assigns each of the at least one surface to a separate one of the at least one hardware layer.

13. The computing device of claim 12 wherein the combined number of the at least one pseudo surface and any remaining ones of the at least one surface is equal to or less than the number of the at least one hardware layer.

14. The computing device of claim 12 wherein the at least one hardware layer comprises at least four hardware layers.

15. The computing device of claim 12 wherein, upon combining the at least two of the at least one surface, the number of the any remaining ones of the at least one surface is zero.

16. The computing device of claim 12 further comprising a display screen in communication with the display hardware.

17. The computing device of claim 12 further comprising a front-end compositor configured to combine the at least one surface to form the at least one pseudo surface using at least one sequential operation.

18. The computing device of claim 17 wherein the any remaining ones of the at least one surface are not processed by the front-end compositor, and the at least one hardware layer is further configured to retrieve the any remaining ones of the at least one surface from the memory.

19. The computing device of claim 12 wherein if the number of the at least one surface is less than or equal to the number of the at least one hardware layer, the processor is configured to send the at least one surface directly to a back-end compositor comprising the at least one hardware layer, the back-end compositor configured to perform computations in parallel.

20. The computing device of claim 12 wherein the processor is further configured to assign certain ones of the at least one surface with a certain characteristic to certain ones of the at least one hardware layer that support the certain characteristic.

21. The computing device of claim 12 wherein if the number of the at least one surface is more than the number of the at least one hardware layer, the processor is further configured to determine at least one possible combination of surfaces to form the at least one pseudo surface, and determine a computation cost associated with each of the at least one possible combination of surfaces.

22. The computing device of claim 21 wherein the processor is further configured to select one of the at least one possible combination of surfaces that has a lowest computation cost.

23. A method performed by a computing device, to compute a cost for potentially combining two or more surfaces into a pseudo surface, comprising:
determining a cost associated with a first factor based on whether or not the surfaces overlap when combined;
determining a cost associated with a second factor based on whether or not at least one of the surfaces comprises two previously combined surfaces;
determining a cost associated with a third factor based on whether or not a color space of any one of the surfaces is to be converted to another color space when combining the surfaces;
determining a cost associated with a fourth factor based on whether or not scaling is used when combining the surfaces; and
summing of the costs associated with any one or any combination of the first, the second, the third and the fourth factors.

24. The method of claim 23 wherein if the surfaces overlap, the cost associated with the first factor increases.

25. The method of claim 24 wherein if at least one of the surfaces comprises two previously combined surfaces, the cost associated with the second factor increases.

26. The method of claim 25 wherein if the color space of any one of the surfaces is to be converted to the other color space, the cost associated with the third factor increases.

27. The method of claim 26 wherein if the scaling is used, the cost associated with the fourth factor increases.
